(19) United States
(12) Patent Application Publication
(10) Pub. No.: US 2008/0144441 A1
(43) Pub. Date: Jun. 19, 2008

(54) Sonar device

(76) Inventor: Frank G. Colangelo, Woodstock, IL (US)

Correspondence Address: Henry C. Query, Jr., 504 S. Pierce Avenue, Wheaton, IL, 60187, US

(21) Appl. No.: 11/827,330

(22) Filed: Jul. 10, 2007

Related U.S. Application Data
(60) Provisional application No. 60/830,167, filed on Jul. 11, 2006.

(51) Int. Cl. G01S 15/06

(52) U.S. Cl. 367/99

(57) ABSTRACT

A sonar device for determining the locations of all sound-reflective objects in all directions within a desired range in a body of water comprises a transmitting transducer and at least three receiving transducers. During operation of the sonar device, the transmitting transducer generates a single omnidirectional pulse which is reflected by the objects and the receiving transducers receive a plurality of echoes from the objects. The sonar device also includes a processor for grouping the echoes received by each receiving transducer into distinct echo sets, mathematically constructing an ellipsoid corresponding to each echo set, and determining the intersections of the ellipsoids to thereby determine the locations of the objects.

This application is based on and claims priority from U.S. Provisional Patent Application No. 60/830,167, which was filed on Jul. 11, 2006.

### BACKGROUND OF THE INVENTION

The present invention is directed to a sonar device for detecting objects in a body of water. In particular, the invention is directed to a sonar device which comprises a transmitting transducer for transmitting a single omnidirectional pulse and which determines the location of each object by calculating the intersection of a number of ellipsoids which are mathematically constructed using the echo sets that are received by a plurality of receiving transducers.

### SUMMARY OF THE INVENTION

In accordance with the present invention, the sonar device comprises a transceiver assembly which includes a plurality of omnidirectional transducers. One of the transducers generates a single, omnidirectional sonar pulse, and all or the remaining transducers detect the returning echoes which emanate from all reflective underwater objects within a desired range. The returning echoes are digitized in an A/D Converter, where information regarding their time of arrival is added. A processor then uses this data to mathematically construct a number of ellipsoids, one for each echo received by each receiving transducer, and then determines the intersections of these ellipsoids. These intersections identify the locations of all the objects.

The objects and advantages of the present invention will be made apparent from the following detailed description, with reference to the accompanying drawings.

### BRIEF DESCRIPTION OF THE DRAWINGS

FIG. 1 is a block diagram of the sonar device of the present invention;

FIG. 2 is a schematic representation of a four-transducer transceiver assembly which is suitable for use in the present invention;

FIG. 3 is a representation of an exemplary transducer which is suitable for use in the present invention;

FIG. 4 is a graph illustrating the procedure for identifying the true start of the echoes in accordance with the present invention;

FIG. 5 is a graph illustrating the procedure for grouping echoes in accordance with the present invention;

FIG. 6 is a graph illustrating the procedure for extracting information from the echoes for use in the equations which determine the intersections of the ellipsoids in accordance with the present invention;

FIG. 6A is a flow chart setting forth the procedure for extracting the information identified in FIG. 6;

FIGS. 7, 8 and 9 are graphs illustrating the procedures for calibrating sonar devices comprising three- and four-transducer transceiver assemblies;

FIG. 10A is a flow chart setting forth the procedure for calibrating a sonar device comprising a three-transducer transceiver assembly;

FIG. 10B depicts the three equations with three unknowns for the procedure involving the three-transducer transceiver assembly;

FIG. 10C is a flow chart setting forth the procedure for calibrating a sonar device comprising a four-transducer transceiver assembly;

FIG. 10D depicts the three equations with three unknowns for the procedure involving the four-transducer transceiver assembly;

### DETAILED DESCRIPTION OF THE INVENTION

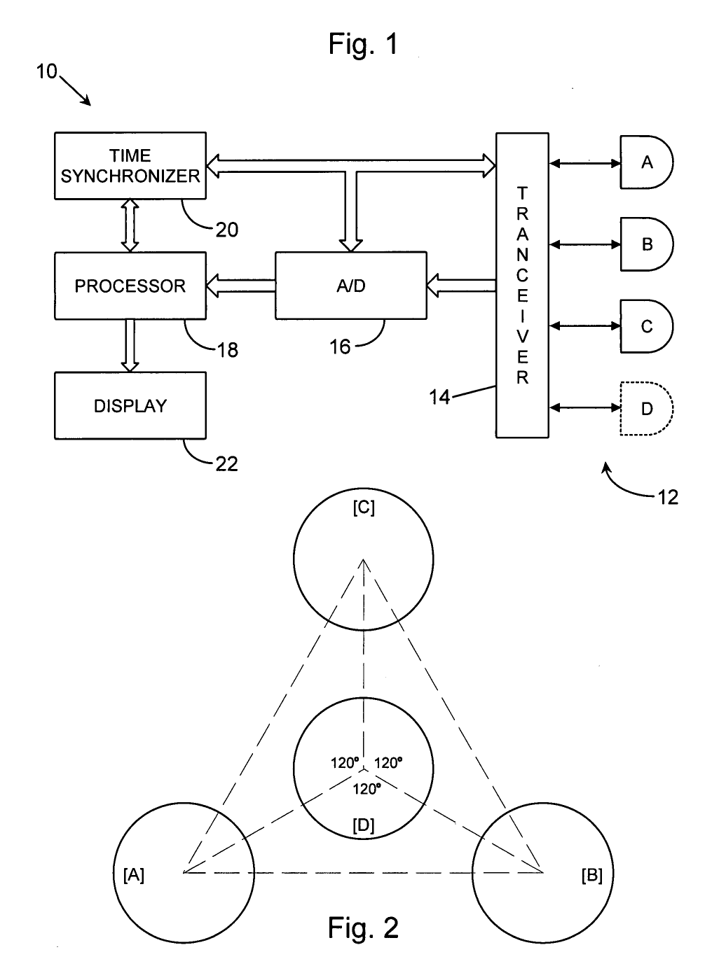

Referring to FIG. 1, an exemplary embodiment of sonar device of the present invention, which is indicated generally by reference number 10, comprises a transceiver assembly 12 which ideally includes a transceiver 14 and three or four transducers A, B, C, D. The transceiver 14 is connected to an analog-to-digital (“A/D”) converter 16 which in turn is connected to a processor 18. The transceiver 14 and the A/D converter 16 are synchronized using a conventional time synchronizer 20, which is controlled by the processor 18.

In a three-transducer transceiver assembly 12, one of the transducers A, B, C functions as both a transmitting transducer and a receiving transducer, and the remaining transducers function as receiving transducers. In a four-transducer transceiver assembly 12, one of the transducers, e.g., transducer D, functions as a transmitting transducer and the remaining transducers A, B, C function as receiving transducers.

The advantage of a four-transducer transceiver assembly 12 is increased range. This results from the fact that, since the transmitting transducer is not used as a receiver, the resonant frequency of the transmitting transducer can be at the maximum impedance point of the receiving transducers.

In the following description, the sonar device 10 will be assumed to comprise a four-transducer transceiver assembly 12. However, those of ordinary skill in the art will readily understand how to apply the teachings of the present invention to a three-transducer transceiver assembly 12.

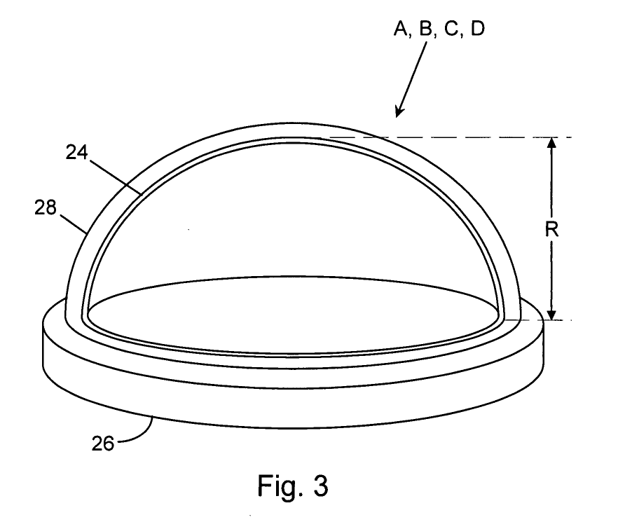

The transducers A, B, C and D are omnidirectional and may be mounted either separately or in a single assembly. In an embodiment of the invention which is illustrated in FIG. 2, the receiving transducers A, B, C are positioned at the vertices of an ideally equilateral triangle, and the transmitting transducer D is mounted in the center of the triangle. The exact orientation of the transducers is determined during the power-up calibration cycle of the sonar device 10.

Referring again to FIG. 1, the transceiver 14 ideally comprises a separate channel for each transducer A, B, C, D, and each channel preferably comprises conventional low and high band pass filters. The sonar pulse is transmitted by transducer D, and the returning echoes are detected by transducers A, B and C. These analog return signals are then transmitted to the A/D converter 16, which ideally comprises a separate channel for each transducer. The A/D converter 16 digitizes the return signals, adds timing information to the signals, and then transmits them to the processor 18, ideally only when the A/D converter detects a change between samples of the analog return signals. This accomplishes data compaction. The A/D converter 16 also sends the processor 18 the number of samples it has received since it last detected a change in the analog return signals.

The processor 18 then uses the digitized return signals and the timing information from the A/D converter 16 to produce echo sets for each of the receiving transducers A, B, C and then mathematically construct three ellipsoids from each echo set. In this regard, it should be understood that an ellipsoid can be a spheroid or a sphere. In accordance with the present invention, the processor 18 then determines the intersection of these ellipsoids to identify the locations of the objects.

The detected objects are then displayed on a display device 22 using known techniques. Each object may be displayed at its X,Y location relative to the sonar device 10 in gray tones, or in a color that corresponds to its Z location, i.e., its depth. Moreover, the strength of the echo may control the brightness of the displayed object. Furthermore, the processor 18 may be provided with a known translational algorithm which will enable the operator to position himself within the display at any X,Y,Z location in order to allow close up views of objects which are identified during initial scans. In addition, the processor 18 may be provided with a readily derivable algorithm which will enable the display 22 to operate in either “normal” or “reveal” mode. In normal mode the display 22 presents the bottom of the body of water as the eye would normally see it. In reveal mode the display 22 strips away the soft sediment to reveal the hard bottom of the body of water.

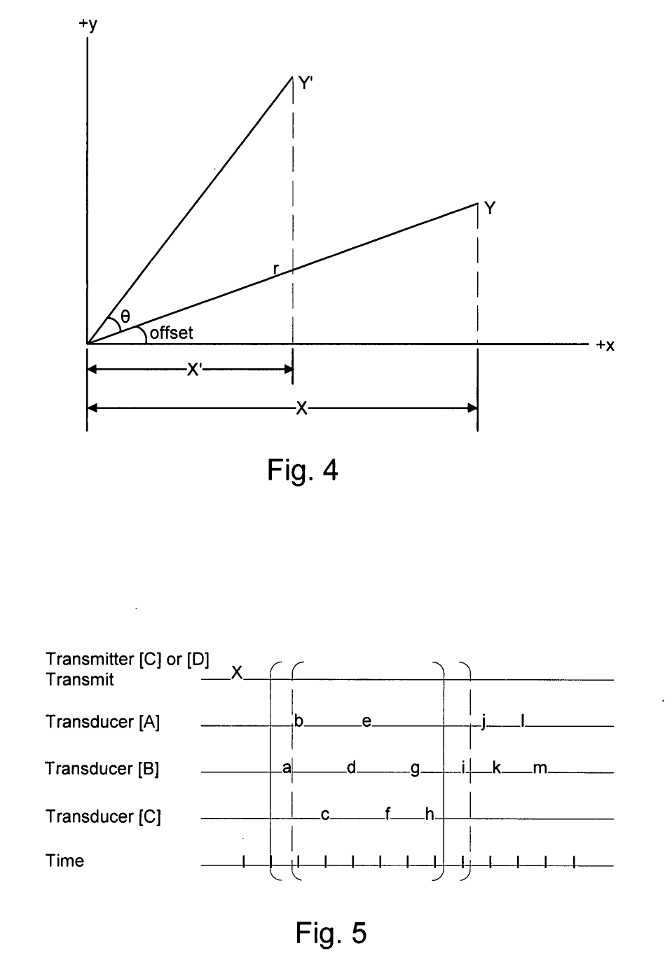

The transducers A, B, C and D may each comprise any conventional omnidirectional transducer which is suitable for use in a sonar device. An exemplary transducer is shown in FIG. 3. The transducer of this embodiment comprises a signal transmitter/receiver 24. The transmitter/receiver 24 may be made of a piezoelectric ceramic material, such as the material designated C5400 by Channel Industries, Inc. of Santa Barbara, Calif. The characteristics of this material are set forth in Table 1. The transmitter/receiver 24 shown in FIG. 3 comprises a hemispherical configuration having a radius R. In one embodiment of the invention, the radius R is about three-quarters of an inch. The transmitter/receiver 24 is secured to a base 26, which is ideally made of a non-electrically conducting, slightly resilient material, such as cork. In addition, the transmitter/receiver 24 preferably includes a protective coating 28 of a quarter wavelength material. The thickness of the coating 28 is less than or equal to one-quarter the wavelength of the transmitting frequency.

TABLE 1
C5400 Hemisphere Specifications

| | Fₘ | Fₙ | | Zₘ | Zₘₙ | Cap | |
|---|---|---|---|---|---|---|---|
| C/N | KHz | KHz | K_{eff} % | dB | dB | pF | Diss % |
| 1 | 63.961 | 72.980 | 48.16 | 13.9 | 90.2 | 3330 | 0.20 |
| 2 | 64.039 | 72.902 | 47.79 | 13.1 | 92.0 | 3230 | 0.20 |
| 3 | 64.118 | 72.980 | 47.76 | 18.4 | 86.2 | 33310 | 0.20 |
| 4 | 64.118 | 73.137 | 48.11 | 13.3 | 91.3 | 3250 | 0.20 |

Echo Identification:

It is possible, and most likely probable, that each receiving transducer A, B, C will receive multiple, overlapping echoes in response to the single pulse generated by the transmitting transducer D. It is therefore important to identify each individual echo, since these echoes may emanate from totally different directions, i.e., different objects.

Once the true start time and amplitude of the first echo has been determined, it can be subtracted from the digitized signal utilizing a single echo pulse train captured during the calibration cycle. The pulse train is scaled down prior to storage to ½ the maximum amplitude of the A/D converter 16 and then scaled up to the identified echo prior to subtraction. Once subtracted, the start of the second echo is revealed, and the process is continued. The sample rate of the A/D converter 16 is ideally two hundred fifty-six times the transmission frequency. Therefore, the time between samples is 360°÷256=1.40625°. If the frequency of transmission is approximately 68.5 KHz, then the time between samples is (1÷68500)÷256=57 nanoseconds. This degree of resolution is desired to minimize the possibility of a blind spot directly below the transducer assembly This is due to the small difference in travel time between objects and the receiving transducers.

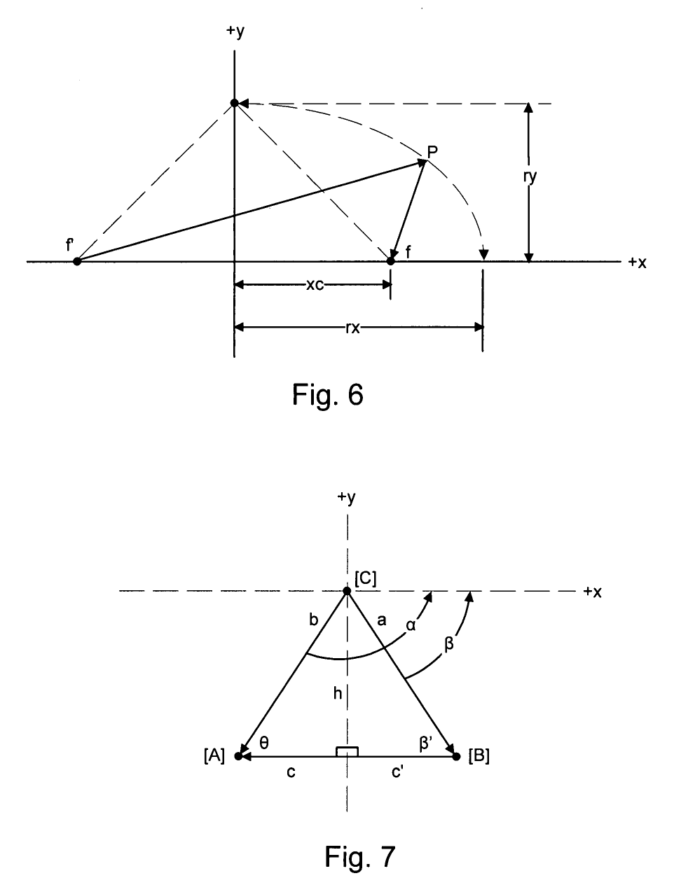

Referring to FIG. 4, the true start of the echo is determined as the difference between the “offset” and the time for the pulse to reach the first sample Y, which is the first sample above zero value. The offset may in turn be derived from the following equation:

$$Sin offset = \frac{Y}{\sqrt{{( \frac{{Y}^{′} - Y cos θ}{sin θ} )}^{2} + {Y}^{2}}} , \qquad ( 1 )$$

where Y′ is the first sample above the Y value and θ is the number of samples between Y and Y′, multiplied by 1.40625°. In FIG. 4, r is equal to the amplitude of the first pulse at 90°, and Y′=X sin θ+Y cos θ.

Target Set Identification:

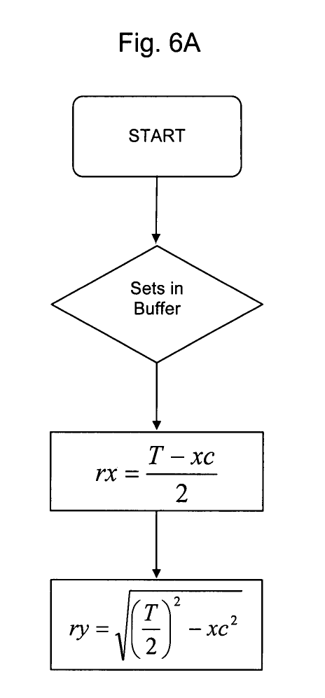

An echo from a single object must arrive at all the receiving transducers A, B, C within a given time frame equal to the maximum delay between the transducers. This time frame will be referred to herein as the “sliding window of opportunity”. Referring to FIG. 5, the window is set at the earliest echo received, and all echoes in the window are used to produce echo sets that are sent for validation as true targets. The window is then moved to the second echo and the process continues.

In FIG. 5, the echoes are represented by the letters a, b, c, d, etc. Thus, the earliest echo is “a”. Also, the first window is represented by the solid brackets, and the second window is represented by the dashed-line brackets. Therefore, the first window echo sets from transducers [A], [B] and [C] are (a,b,c), (a,b,f), (a,b,h), (a,c,e), (a,e,f), and (a,e,h).

Converting Echoes into Equations:

As the echo sets are identified, each must be converted into an equation for an ellipsoid or a sphere having three unknowns, x, y and z. These ellipsoids are then rotated into the standard position and adjusted for the amount of x offset in the equations.

The following is the equation for an ellipsoid in its standard position:

$${( \frac{x}{rx} )}^{2} + {( \frac{y}{ry} )}^{2} + {( \frac{z}{rz} )}^{2} = 1 \qquad ( 2 )$$

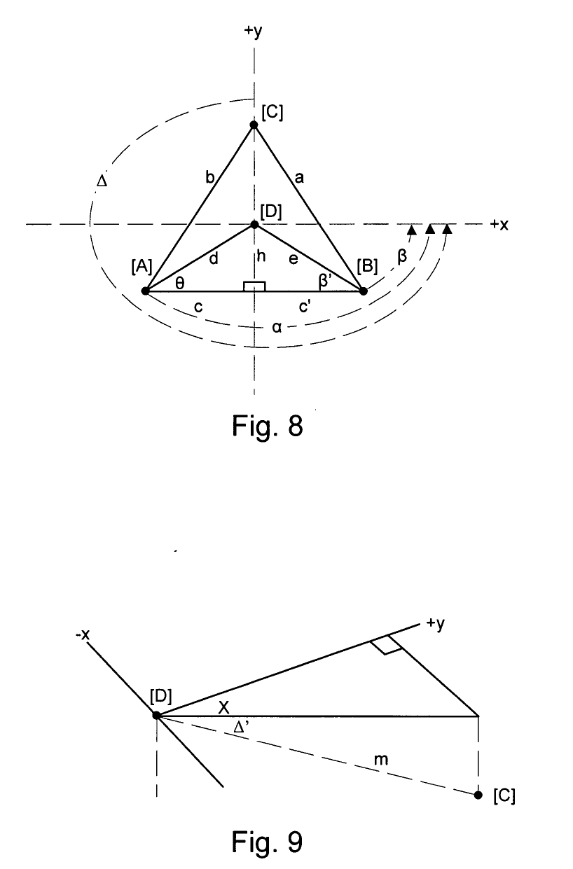

Referring to FIG. 6, f′ represents the location of the transmitting transducer, f represents the location of a receiving transducer and P represents the location of the target.

Thus, the objective is to find the values of rx and ry for each echo. These may be determined using the procedure set forth in FIG. 6A, wherein T represents the time for the echo to travel from the transmitter f′ to the target P and then back to the receiver f.

Calibration Procedure:

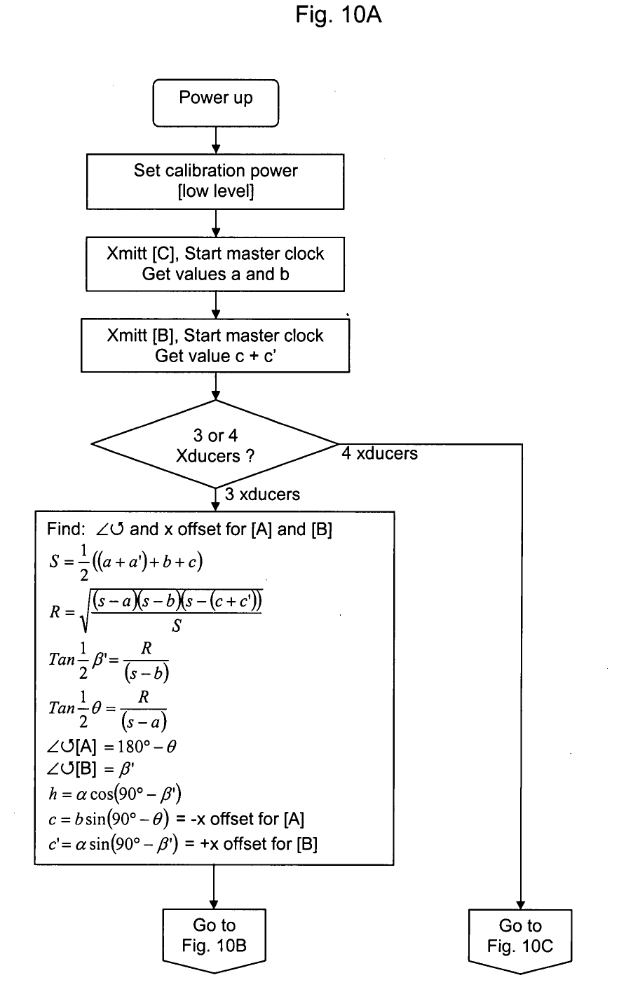

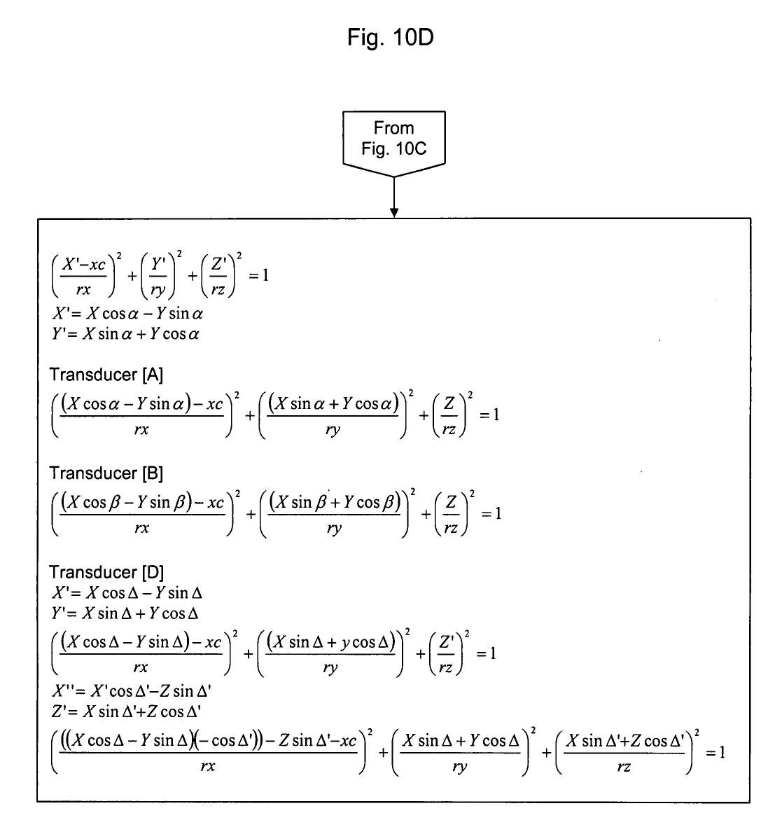

Referring to FIG. 7 for an understanding of the variables involved, the procedure for calibrating a three-transducer transceiver assembly is set forth in FIGS. 10A and 10B. In FIG. 10B, since the distance from the transmitter to the target is known, the equations can be simplified to three spheres with three unknowns.

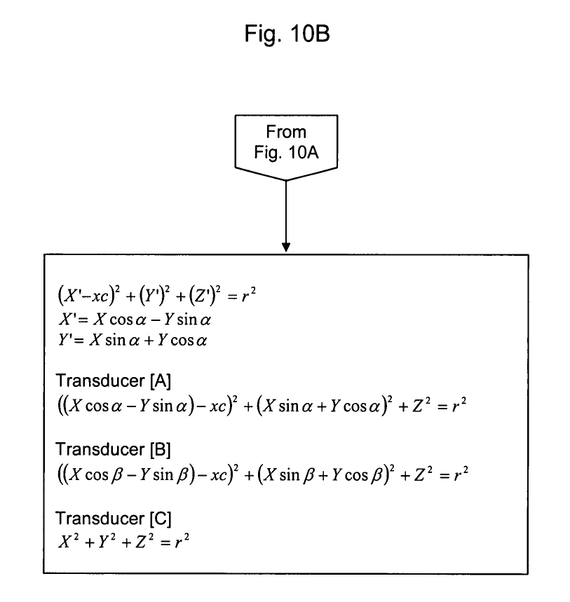

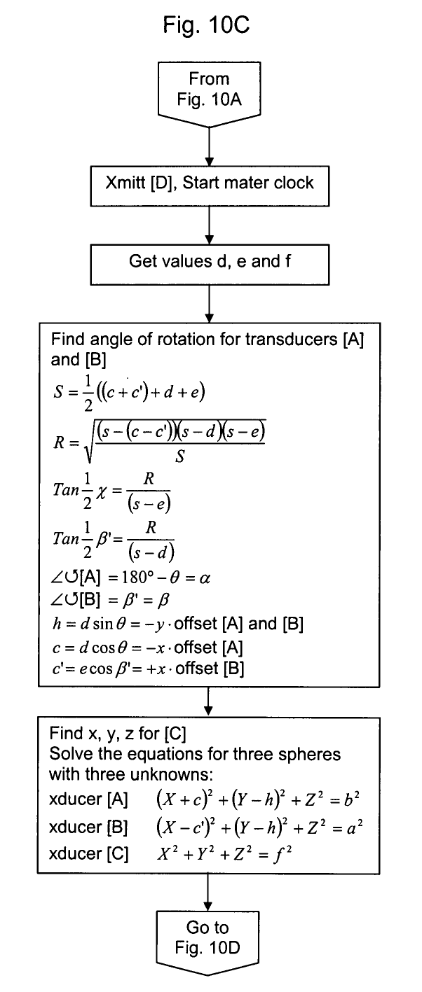

Referring to FIGS. 8 and 9 for an understanding of the variables involved, the procedure for calibrating a four-transducer transceiver assembly is set forth in FIGS. 10C and 1 OD. In FIG. 8, the following assumptions are made: transducers A, B and D are located on the XY plane; transducer D is located at the point x, y, z=(0,0,0); and line c+c′ is parallel to the x axis. Moreover, transducer D is installed at a slight +z offset to the plane containing transducers A, B and C. Therefore, transducer C will have a slight −z offset to the plane containing the transducers A, B and D. Also, in FIG. 9, since transducer D is located at f′ for all ellipsoids and is located at x, y, z=(0,0,0), then xc=½ m and yc and zc are 0 after rotation.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

I claim:

1. A sonar device for determining the locations of all sound-reflective objects in all directions within a desired range in a body of water, the sonar device comprising:
a transmitting transducer;
at least three receiving transducers;
wherein during operation of the sonar device, the transmitting transducer generates a single omnidirectional sonar pulse which is reflected by the objects and the receiving transducers receive a plurality of echoes from the objects;
a processor for grouping the echoes received by each receiving transducer into distinct echo sets, mathematically constructing an ellipsoid corresponding to each echo set, and determining the intersections of the ellipsoids to thereby determine the locations of the objects.

2. The sonar device of claim 1, wherein one of the receiving transducers comprises the transmitting transducer.

3. The sonar device of claim 1, wherein each of the transmitting and receiving transducers comprises a piezoelectric ceramic transmitter/receiver.

4. The sonar device of claim 3, wherein the transmitter/receiver comprises a hemispherical configuration.

5. The sonar device of claim 4, wherein the transmitter/receiver comprises a radius of approximately three-quarters of an inch.

6. The sonar device of claim 1, wherein the at least three receiving transducers comprise three receiving transducers which are distinct from the transmitting transducer.

7. The sonar device of claim 6, wherein the receiving transducers are positioned at approximately the vertices of an equilateral triangle.

8. The sonar device of claim 7, wherein the transmitting transducer is positioned at approximately the center of the triangle.

9. A method for determining the locations of all sound-reflective objects in all directions within a desired range in a body of water, the method comprising:
providing a transmitting transducer for generating a single omnidirectional sonar pulse;
providing at least three receiving transducers for receiving a plurality of echoes which are reflected by the objects;
grouping the echoes received by each receiving transducer into distinct echo sets;
mathematically constructing an ellipsoid corresponding to each echo set; and
determining the intersections of the ellipsoids to thereby determine the locations of the objects.

10. The method of claim 9, wherein one of the receiving transducers comprises the transmitting transducer.

11. The method of claim 9, wherein the at least three receiving transducers comprise three receiving transducers which are distinct from the transmitting transducer.

12. The method of claim 11, wherein the receiving transducers are positioned at approximately the vertices of an equilateral triangle.

13. The method of claim 12, wherein the transmitting transducer is positioned at approximately the center of the triangle.
